(19) United States
(12) Patent Application Publication
(10) Pub. No.: US 2026/0351218 A1
(43) Pub. Date: Nov. 5, 2026

(54) METHOD AND DEVICE FOR PROCESSING DISPLAY DATA

(71) Applicant: Wuhan Tianma Microelectronics Co., Ltd., Wuhan (CN)

(72) Inventors: Shuo TANG, Wuhan (CN); Chuan LIU, Wuhan (CN); Xun XIAO, Wuhan (CN)

(73) Assignee: Wuhan Tianma Microelectronics Co., Ltd., Wuhan (CN)

(21) Appl. No.: 19/710,494

(22) Filed: Jun. 17, 2026

(30) Foreign Application Priority Data
Feb. 5, 2026 (CN) 202610170336.5

(51) Int. Cl. G09G 5/00

(52) U.S. Cl. CPC G09G 5/003; G09G 2320/0276; G09G 2320/0626; G09G 2320/0693; G09G 2360/16

(57) ABSTRACT

Provided are a method and a device for processing display data. The method includes: setting n first grayscale nodes, including a 1st node to an nth node whose grayscale values increase progressively; acquiring first register values of a first display module at the 1st node to the nth node; acquiring first coefficients of the 1st node to an (n−1)th node according to the first register values; acquiring a second register value of a second display module at the nth node; acquiring second register values of the second display module at the 1st node to the (n−1)th node according to the acquired second register value and the first coefficients of the 1st node to the (n−1)th node; and burning the second register values into the second display module.

### CROSS-REFERENCE TO RELATED APPLICATIONS

The present application claims priority to Chinese Patent Application No. 202610170336.5, filed on Feb. 5, 2026, the content of which is incorporated herein by reference in its entirety.

### TECHNICAL FIELD

The present disclosure relates to the field of display technologies, and, in particular, to a method and a device for processing display data.

### BACKGROUND

A display module includes a display panel and a driving chip, and initial register values are stored in the driving chip. However, since the initial register values are general preset values and cannot match individual process differences of the display panel, register values need to be processed, and the panel is driven to display based on the processed register values.

However, the processing manner for register values in the related art is unsatisfactory, resulting in display defects of the display panel and further affecting visual effects.

### SUMMARY

Embodiments of the present disclosure provide a method and a device for processing display data, which are used to improve the reliability of processing display data of a display panel.

In a first aspect, the present disclosure provides a method for processing display data, including: setting n first grayscale nodes, where the first grayscale nodes include a 1st node to an nth node, and grayscale values of the 1st node to the nth node increase progressively, where n>1; acquiring first register values respectively corresponding to a first display module at the 1st node to the nth node, where the first register values are register values for driving the first display module to display target brightness at the first grayscale nodes respectively; acquiring first coefficients respectively corresponding to the 1st node to an (n−1)th node according to the acquired first register values; acquiring a second register value corresponding to a second display module at the nth node, where the second register value corresponding to the second display module at the nth node is a register value for driving the second display module to display target brightness at the nth node; acquiring second register values respectively corresponding to the second display module at the 1st node to the (n−1)th node according to the acquired second register value corresponding to the second display module at the nth node and the acquired first coefficients respectively corresponding to the 1st node to the (n−1)th node; and burning the second register values corresponding to the second display module at the n first grayscale nodes into the second display module.

In a second aspect, the present disclosure further provides a device for processing display data, corresponding to the method for processing display data described above, including: a setting module, an acquisition module, a first processing module, a second processing module, and a burning module.

The setting module is configured to set n first grayscale nodes, where n>1. The first grayscale nodes include a 1st node to an nth node, and grayscale values of the 1st node to the nth node increase progressively.

The acquisition module is configured to acquire first register values respectively corresponding to a first display module at the 1st node to the nth node, and acquire a second register value corresponding to a second display module at the nth node, the first register values are register values for driving the first display module to display target brightness at the first grayscale nodes respectively, and the second register value corresponding to the second display module at the nth node is a register value for driving the second display module to display target brightness at the nth node.

The first processing module is configured to acquire first coefficients respectively corresponding to the 1st node to an (n−1)th node according to the acquired first register values.

The second processing module is configured to acquire second register values respectively corresponding to the second display module at the 1st node to the (n−1)th node according to the acquired second register value corresponding to the second display module at the nth node and the acquired first coefficients respectively corresponding to the 1st node to the (n−1)th node.

The burning module is configured to burn the second register values corresponding to the second display module at the n first grayscale nodes into the second display module.

The technical solutions according to the embodiments of the present disclosure have the following beneficial effects.

In the above processing manner according to the embodiments of the present disclosure, register values of the first display module at the n first grayscale nodes are separately corrected to obtain n first register values, and the first coefficients respectively corresponding to the 1st node to the (n−1)th node are acquired according to the n first register values. These first coefficients may reflect the correlation between the first register values corresponding to different first grayscale nodes. Further, in the second display module, only a register value of the second display module at the nth node is corrected to obtain the second register value corresponding to the second display module at the nth node. Combined with the first coefficients, the second register values corresponding to the second display module at the 1st node to the (n−1)th node are directly acquired. Further, the second register value of the second display module at the nth node obtained by correction and the second register values of the second display module at the 1st node to the (n−1)th node calculated based on the first coefficients are all burned into a driving chip of the second display module, and all are used as reference bases for other grayscales, for example, as calculation bases for register values of other grayscales between adjacent first grayscale nodes, thereby improving reliability of the obtained register values of other grayscales, and optimizing the gamma curve.

In the embodiments of the present disclosure, register values of a greater number of grayscale nodes may be burned into the second display module, to provide more references for calculation of register values of other grayscales. In addition, the burned register values of these grayscale nodes only need to be obtained according to the first coefficients without performing a complicated correction process on the basis of initial register values, so that the time of the OTP process is not greatly affected.

Exemplarily, the nth node may be understood as an anchor grayscale, and the 1st node to the (n−1)th node may be understood as non-anchor grayscales. In the related art, only register values of anchor grayscales are burned into the display module, and register values of other non-anchor grayscales are calculated only based on the register values of these anchor grayscales. In the embodiments of the present disclosure, some non-anchor grayscales may be set as the 1st node to the (n−1)th node, register values of the second display module at the 1st node to the (n−1)th node are obtained based on the above processing manner, and these register values are burned together with the register value of the anchor grayscale, so as to provide more references for calculation of register values of other grayscales.

Further, the above processing manner according to the embodiments of the present disclosure may be applied to a low-grayscale range.

During research, it has been found that in the related art, a linear interpolation algorithm is generally used to process register values of grayscales in a low-grayscale range, but the register values acquired in this way differ greatly from register values actually required by the display panel, resulting in unsmooth gamma in the low-grayscale range. If low grayscales are directly processed using a debugging algorithm corresponding to high grayscales, in a process of processing register values of the low grayscales, register value ratios among different color channels need to be continuously corrected according to chromaticity data measured by an instrument. This process greatly prolongs the correction time and slows down the production line takt time. In addition, the measured chromaticity data of the instrument at low brightness has a large error. Adjusting the register value ratios based on such erroneous data causes the correction direction to deviate, and instead results in more serious color cast.

By adopting the processing manner according to the embodiments of the present disclosure, the above problems can be effectively overcome. In the embodiments of the present disclosure, the n first grayscale nodes may be set in one low-grayscale range, and then register values corresponding to a greater number of lower grayscales are burned into the second display module based on the foregoing processing manner as reference values, so as to optimize reliability of the register values in the entire low-grayscale range. Such a manner can not only overcome the problem of unsmooth gamma at low grayscales caused by the linear interpolation algorithm and effectively improve low-grayscale visual effects, but also overcome the serious color cast problem caused by causing the low grayscales to follow the debugging algorithm corresponding to high grayscales, and does not greatly increase correction time, thereby keeping the Takt Time (TT) baseline.

### BRIEF DESCRIPTION OF DRAWINGS

In order to more clearly illustrate the embodiments of the present disclosure or the technical solutions in the related art, the accompanying drawings are briefly introduced below. The accompanying drawings in the following description are some embodiments of the present disclosure, and for those skilled in the art, other accompanying drawings may be obtained according to these accompanying drawings without any creative efforts.

FIG. 1 is a schematic diagram of a method for processing display data according to an embodiment of the present disclosure;

FIG. 2 is a curve comparison schematic diagram of grayscale-register values according to an embodiment of the present disclosure;

FIG. 3 is a comparison schematic diagram of a gamma curve according to an embodiment of the present disclosure;

FIG. 4 is another curve comparison schematic diagram of grayscale-register values according to an embodiment of the present disclosure;

FIG. 5 is another comparison schematic diagram of a gamma curve according to an embodiment of the present disclosure;

FIG. 6 is a schematic diagram of brightness ranges according to an embodiment of the present disclosure;

FIG. 7 is another schematic diagram of a method for processing display data according to an embodiment of the present disclosure;

FIG. 8 is a schematic diagram of a device for processing display data according to an embodiment of the present disclosure; and

FIG. 9 is another schematic diagram of a device for processing display data according to an embodiment of the present disclosure.

### DESCRIPTION OF EMBODIMENTS

In order to better understand the technical solutions of the present disclosure, embodiments of the present disclosure will be described in detail below with reference to the drawings.

It should be clear that the described embodiments are merely some of the embodiments of the present disclosure rather than all of the embodiments. Based on the embodiments of the present disclosure, all other embodiments obtained by those of ordinary skill in the art shall fall within the protection scope of the present disclosure.

Terms used in the embodiments of the present disclosure are merely for the purpose of describing specific embodiments, rather than limiting the present disclosure. Singular forms of “a/an”, “said” and “the” used in the embodiments of the present disclosure and the appended claims are also intended to include plural forms, unless the context clearly indicates other meaning otherwise.

It should be understood that the term “and/or” used herein is merely an association relationship describing an associated object, indicating that there may be three relationships, for example, A and/or B, and may indicate: only A, both A and B, and only B. In addition, the character “/” herein generally indicates that the related objects present an“or” relationship.

The embodiments of the present disclosure provide a method for processing display data, which is configured to process register values corresponding to grayscales.

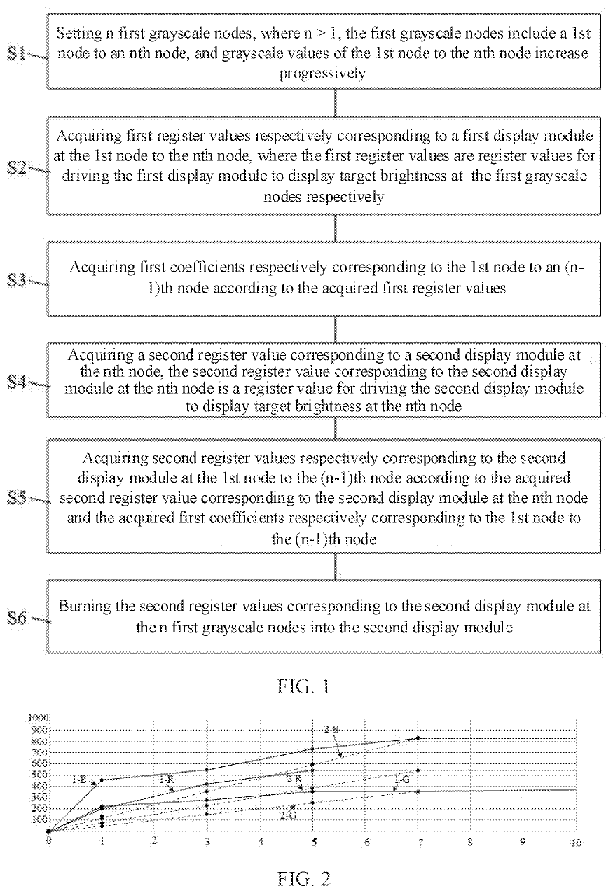

FIG. 1 is a schematic diagram of a method for processing display data according to an embodiment of the present disclosure. As shown in FIG. 1, the method for processing display data includes the following steps.
Step S1: n first grayscale nodes are set, where n>1. The n first grayscale nodes include a 1st node to an nth node, and grayscale values of the 1st node to the nth node increase progressively.

In the embodiments of the present disclosure, other grayscales may be spaced between two adjacent first grayscale nodes, and quantities of grayscales spaced between different adjacent first grayscale nodes may be the same or may be different.
Step S2: first register values respectively corresponding to a first display module at the 1st node to the nth node are acquired. The first register values are register values for driving the first display module to display target brightness at a corresponding first grayscale node, and may also be understood as a corrected register value corresponding to the first display module at the first grayscale node.

The process of acquiring the first register values may specifically include driving a display panel in the first display module to display based on initial register values corresponding to the first grayscale nodes, collecting actual brightness of the display panel using an instrument, comparing the collected brightness with the target brightness, and adjusting the register values according to a comparison result until the collected brightness is consistent with the target brightness. In this case, the adjusted register values are the first register values.
Step S3: first coefficients respectively corresponding to the 1st node to an (n−1)th node are acquired according to the acquired first register values.
Step S4: a second register value corresponding to the second display module at the nth node is acquired. The second register value corresponding to the second display module at the nth node is a register value for driving the second display module to display the target brightness at the nth node, and may also be understood as a corrected register value corresponding to the second display module at the nth node.

The process of acquiring the second register value corresponding to the second display module at the nth node may specifically include driving a display panel in the second display module to display based on an initial register value corresponding to the nth node, collecting actual brightness of the display panel using the instrument, comparing the collected brightness with the target brightness, and adjusting the register value according to the comparison result until the collected brightness is consistent with the target brightness. In this case, the adjusted register value is the second register value corresponding to the second display module at the nth node.
Step S5: second register values respectively corresponding to the second display module at the 1st node to the (n−1)th node are acquired according to the acquired second register value corresponding to the second display module at the nth node and the acquired first coefficients respectively corresponding to the 1st node to the (n−1)th node.
Step S6: the second register values corresponding to the second display module at the n first grayscale nodes are burned into the second display module.

In the above processing manner according to the embodiments of the present disclosure, register values of the first display module at the n first grayscale nodes are separately corrected to obtain n first register values, and the first coefficients respectively corresponding to the 1st node to the (n−1)th node are acquired according to the n first register values. These first coefficients may reflect the correlation between the first register values corresponding to different first grayscale nodes. Further, in the second display module, only a register value of the second display module at the nth node is corrected to obtain the second register value corresponding to the second display module at the nth node. Combined with the first coefficients, the second register values corresponding to the second display module at the 1st node to the (n−1)th node are directly acquired. Further, the second register value of the second display module at the nth node obtained by correction and the second register values of the second display module at the 1st node to the (n−1)th node calculated based on the first coefficients are all burned into a driving chip of the second display module, and all are used as reference bases for other grayscales, for example, as calculation bases for register values of other grayscales between adjacent first grayscale nodes. The register values of the other grayscales between adjacent first grayscale nodes may be obtained using a linear interpolation algorithm based on register values of the adjacent first grayscale nodes, thereby improving reliability of the obtained register values of the other grayscales, and further optimizing the gamma curve.

In the embodiments of the present disclosure, register values of a greater number of grayscale nodes may be burned into the second display module, to provide more references for calculation of register values of other grayscales. In addition, the burned register values of these grayscale nodes only need to be obtained according to the first coefficients without performing a complicated correction process on the basis of initial register values, so that the time of a One-Time Programmable (OTP) process is not greatly affected.

Exemplarily, the nth node may be understood as an anchor grayscale, and the 1st node to the (n−1)th node may be understood as non-anchor grayscales. In the related art, only register values of anchor grayscales are burned into the display module, and register values of other non-anchor grayscales are calculated only based on the register values of these anchor grayscales. In the embodiments of the present disclosure, some non-anchor grayscales may be set as the 1st node to the (n−1)th node, register values of the second display module at the 1st node to the (n−1)th node are obtained based on the above processing manner, and these register values are burned together with the register value of the anchor grayscale, so as to provide more references for calculation of register values of other grayscales.

Further, the above processing manner according to the embodiments of the present disclosure may be applied to a low-grayscale range.

During research, it has been found that in the related art, a linear interpolation algorithm is generally used to process register values of grayscales in a low-grayscale range, but the register values acquired in this way differ greatly from register values actually required by the display panel, resulting in unsmooth gamma in the low-grayscale range.

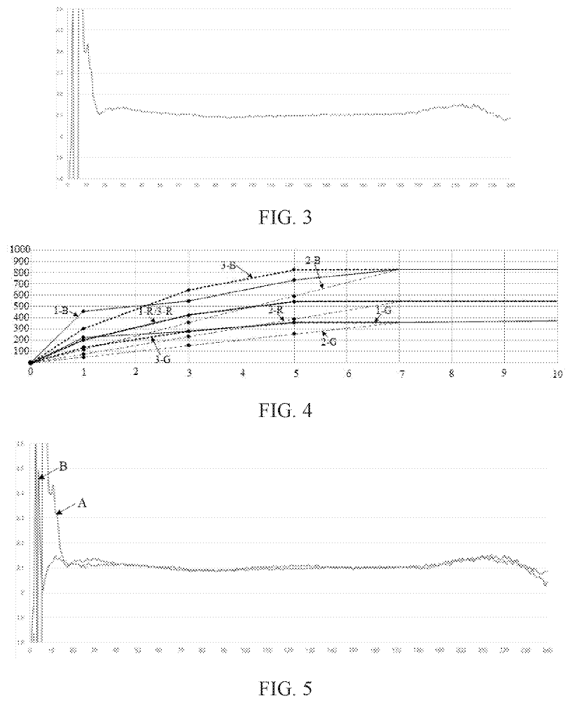

Taking the grayscale range [0-7] as an example, grayscale 7 is an anchor grayscale. FIG. 2 is a curve comparison schematic diagram of grayscale-register values according to an embodiment of the present disclosure. 1-R, 1-G, and 1-B are used to reflect register values actually required when the display panel displays target brightness of grayscales in a red channel, a green channel, and a blue channel, and 2-R, 2-G, and 2-B are used to reflect register values corresponding to grayscales of the display panel in the red channel, the green channel, and the blue channel obtained using a processing manner of linear interpolation in the related art. In the related art, only the register value of grayscale 7 is corrected and burned and then register values of grayscale 1 to grayscale 6 are calculated according to the burned register value of grayscale 7 and a linear interpolation formula. However, referring to FIG. 2, the register values of grayscale 1 to grayscale 6 obtained in this way differ greatly from the register values required when the display panel displays the target brightness at grayscale 1 to grayscale 6, resulting in unsmooth gamma in this grayscale range. FIG. 3 is a comparison schematic diagram of a gamma curve according to an embodiment of the present disclosure. As shown in FIG. 3, the gamma value in this grayscale range fluctuates greatly, which may cause problems such as obvious dark-area color cast and detail loss.

Further, it has been found through research that if low grayscales are directly processed using a debugging algorithm corresponding to high grayscales, in a process of processing register values of the low grayscales, register value ratios among different color channels need to be continuously corrected according to chromaticity data measured by an instrument. This process greatly prolongs the correction time and slows down the production line takt time. In addition, the measured chromaticity data of the instrument at low brightness has a large error. Adjusting the register value ratios based on such erroneous data causes the correction direction to deviate and, instead, results in more serious color cast.

By adopting the processing manner according to the embodiments of the present disclosure, the above problems can be effectively overcome. In the embodiments of the present disclosure, the n first grayscale nodes may be set in one low-grayscale range, and then register values corresponding to a greater number of lower grayscales are burned into the second display module based on the foregoing processing manner as reference values, so as to optimize reliability of the register values in the entire low-grayscale range. Such a manner can not only overcome the problem of unsmooth gamma at low grayscales caused by the linear interpolation algorithm and effectively improve low-grayscale visual effects, but also overcome the serious color cast problem caused by causing the low grayscales to follow the debugging algorithm corresponding to high grayscales, and does not greatly increase correction time, thereby keeping the Takt Time (TT) baseline.

Still taking the grayscale range [0-7] as an example, grayscale 7 is the nth node, and grayscale 1, grayscale 3, and grayscale 5 are set to be the 1st node to the (n−1)th node. After the register value of grayscale 7 is corrected, register values of grayscale 1, grayscale 3, and grayscale 5 are obtained based on the first coefficients. FIG. 4 is another curve comparison schematic diagram of grayscale-register values according to an embodiment of the present disclosure. 3-R, 3-G, and 3-B are used to reflect register values corresponding to grayscales of the display panel in the red channel, the green channel, and the blue channel obtained using the processing manner according to an embodiment of the present disclosure. Referring to FIG. 4, differences between register values of grayscale 1 to grayscale 6 obtained using the processing manner and register values actually required by the display panel at grayscale 1 to grayscale 6 are far smaller than differences between register values of grayscale 1 to grayscale 6 obtained using the linear interpolation algorithm and register values actually required by the display panel at grayscale 1 to grayscale 6, thereby significantly improving gamma in the grayscale range. FIG. 5 is another comparison schematic diagram of gamma curves according to an embodiment of the present disclosure. A represents a gamma curve corresponding to the related art, and B represents a gamma curve corresponding to the embodiments of the present disclosure. It can be seen from FIG. 5 that, after the register values are processed using the processing manner of the embodiments of the present disclosure, a fluctuation degree of gamma values corresponding to the low-grayscale range is significantly reduced, and the gamma curve can be effectively corrected.

In addition, in the embodiments of the present disclosure, among the 1st node to the nth node, the register value of the nth node is selected to be corrected, and then the register values corresponding to the 1st node to the (n−1)th node are calculated and obtained based on the first coefficients. The grayscale value of the nth node is relatively high, and the corresponding brightness is relatively large. Therefore, an error when the instrument collects brightness is relatively small. Selecting the register value of the nth node to be corrected is less affected by the error of brightness collection by the instrument, the correction reliability is higher, and the obtained register values of the 1st node to the (n−1)th node are also more accurate.

In addition, for the first display module, the first register values at the n first grayscale nodes obtained by correction may be directly burned into the first display module. Alternatively, similar to the second display module, register values corresponding to the 1st node to the (n−1)th node may also be calculated and obtained based on the first register value at the nth node and the first coefficients, and then the first register value at the nth node obtained by correction and the register values at the 1st node to the (n−1)th node calculated based on the first coefficients are burned into the first display module.

In a feasible implementation, the first display module is a test display module, and the second display module is a display module to be burned.

The test display module is configured to independently correct register values corresponding to the 1st node to the (n−1)th node according to brightness collected using an instrument, to provide first coefficients required for calculation for other display modules to be burned in the same batch.

The test display module and the display module to be burned may be in the same batch, that is, display panels in the test display module and the display module to be burned are produced in the same production line. In this way, individual differences caused by fluctuations in a panel production process can be reduced, so that the first coefficients obtained based on the test display module can better adapt to other display modules to be burned, and further the second register values corresponding to the 1st node to the (n−1)th node obtained by the display module to be burned based on the first coefficients are closer to register values actually required when the display module to be burned displays the target brightness.

In a feasible implementation, the brightness value corresponding to the 1st node is greater than or equal to 0.0005 nit, that is, the target brightness corresponding to the 1st node is greater than or equal to 0.0005 nit.

The 1st node has the minimum grayscale value among the n first grayscale nodes, and the brightness magnitude thereof can reflect the minimum brightness boundary of the brightness range where the n first grayscale nodes are located. By making the brightness value corresponding to the 1st node greater than or equal to 0.0005 nit, it can be avoided that the brightness range where the n first grayscale nodes are located is excessively low, thereby ensuring that the measurement error of the instrument in this brightness range is relatively small. Further, when a register value is corrected based on measured brightness in a chip-by-chip adjustment process, the reliability of correction can be improved. Correspondingly, the reliability of the subsequently obtained first coefficients and the second register values of the second display module at the 1st node to the (n−1)th node is also correspondingly improved, thereby avoiding obvious color cast of the second display module under low-brightness and low-grayscale conditions.

In a feasible implementation, the brightness value corresponding to the nth node is less than or equal to 0.01 nit, that is, target brightness corresponding to the nth node is less than or equal to 0.01 nit.

The nth node has the maximum grayscale value among the n first grayscale nodes, and the brightness magnitude thereof can reflect the maximum brightness boundary of the brightness range where the n first grayscale nodes are located. In the brightness range above 0.01 nit, the accuracy of measurement data of the instrument is greatly improved. For example, the collection of chromaticity data by the instrument is relatively accurate. Therefore, in the brightness range above 0.01 nit, another more adaptive processing manner may be selected for processing. In addition, when the brightness value corresponding to the nth node is less than or equal to 0.01 nit, the length of the brightness range where the n first grayscale nodes are located is relatively reasonable, so that the gamma reliability corresponding to a plurality of grayscales in the brightness range can be ensured on the premise that the set quantity of the first grayscale nodes is reasonable. Alternatively, in other words, while ensuring the gamma reliability corresponding to the grayscales in the brightness range, the set quantity of the first grayscale nodes does not need to be excessively large, thereby saving the correction duration for the first display module, and saving the calculation and burning duration of the register values of the 1st node to the (n−1)th node in the second display module.

In a feasible implementation, the process of step S1 may include dividing a first brightness range, a second brightness range and a third brightness range according to panel brightness and setting the n first grayscale nodes in the second brightness range.

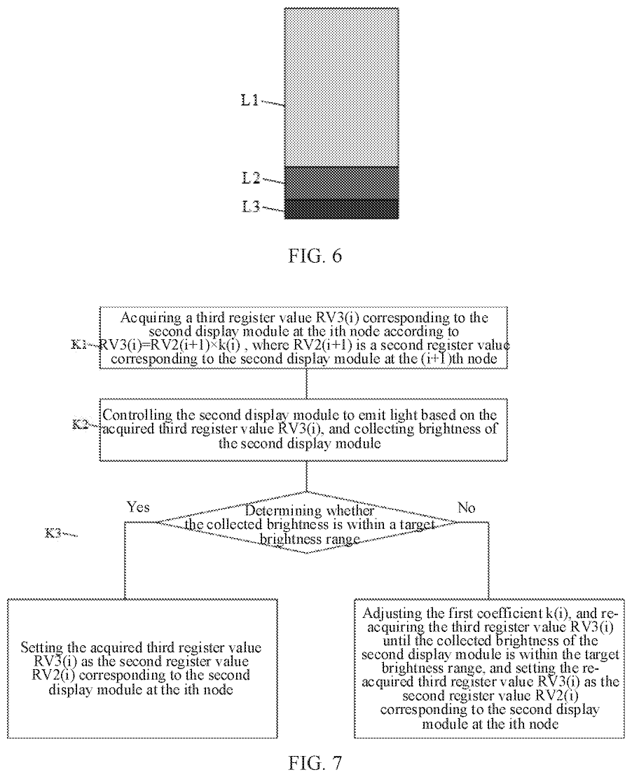

FIG. 6 is a schematic diagram of brightness ranges according to an embodiment of the present disclosure. As shown in FIG. 6, the brightness values in the first brightness range L1 are greater than the brightness values in the second brightness range L2, and the brightness values in the second brightness range L2 are greater than the brightness values in the third brightness range L3.

In the embodiments of the present disclosure, a plurality of different brightness ranges are divided, and then the n first grayscale nodes are set in a certain brightness range, so that the processing manner of the embodiments of the present disclosure is applied to grayscales in the brightness range in a targeted manner. For example, as described above, in the related art, the processing manner in the low-grayscale range is poor, which causes some adverse problems. Therefore, in the embodiments of the present disclosure, a low-brightness second brightness range may be divided, to improve low-grayscale visual effects in a targeted manner.

Further, the second brightness range is [0.0005 nit, 0.01 nit].

In the embodiments of the present disclosure, the second brightness range may be divided according to characteristics of the instrument. When the brightness is lower than 0.0005 nit, the measurement error of the instrument on the brightness is relatively large. By setting the minimum brightness value in the second brightness range to be 0.0005 nit, when register values of the n first grayscale nodes are corrected in the first display module according to comparison between collected brightness and target brightness, the correction reliability is relatively high. Correspondingly, the reliability of the subsequently obtained first coefficients and the second register values of the second display module at the 1st node to the (n−1)th node is also correspondingly improved, thereby avoiding obvious color cast of the second display module under low-brightness and low-grayscale conditions. When the brightness is higher than 0.01 nit, the accuracy of the measurement data of the instrument is greatly improved. For example, the collection of chromaticity data by the instrument is relatively accurate. Therefore, in the brightness range above 0.01 nit, another more adaptive processing manner may be selected for processing.

In addition, within the above brightness range, the length of the second brightness range is relatively reasonable, so that the gamma reliability corresponding to a plurality of grayscales in the brightness range can be ensured on the premise that the set quantity of the first grayscale nodes is reasonable. Alternatively, in other words, while ensuring the gamma reliability corresponding to the grayscales in the brightness range, the set quantity of the first grayscale nodes does not need to be excessively large, thereby saving the correction duration for the first display module, and saving the calculation and burning duration of the register values of the 1st node to the (n−1)th node in the second display module.

In addition, when the second brightness range is [0.0005 nit, 0.01 nit], the second brightness range corresponds to a low-grayscale and low-brightness range. It can be seen from the foregoing analysis that, when the processing manner in the embodiments of the present disclosure is used to process the register values corresponding to grayscales in this brightness range, the problem of unsmooth gamma caused by the linear interpolation algorithm can be overcome and low-grayscale visual effects can be effectively improved, the serious color cast problem caused by causing low grayscales to follow a debugging algorithm corresponding to high grayscales can also be overcome, and the correction time is not greatly increased, thereby keeping the TT baseline.

In a feasible implementation, the method for acquiring the display data further includes: for at least one display brightness value, obtaining register values corresponding to grayscales of the second display module in the third brightness range through a linear interpolation algorithm according to a register value corresponding to grayscale 0 and the acquired second register value corresponding to the second display module at the 1st node.

In the embodiments of the present disclosure, the register value corresponding to grayscale 0 may be 0.

The brightness values in the third brightness range are very low, for example, below 0.0005 nit, and the measurement error of the instrument in the brightness range is relatively large. Therefore, when the third brightness range covers grayscales, if register values of these grayscales are corrected based on brightness collected by the instrument, the correction result is also inaccurate. Therefore, for the third brightness range, according to the embodiments of the present disclosure, the register values corresponding to the grayscales covered by the third brightness range may be directly obtained through a linear interpolation algorithm according to the register value corresponding to grayscale 0 and the previously obtained second register value corresponding to the second display module at the 1st node, thereby omitting correction and burning for the third brightness range.

In the related art, the register values of the grayscales in the third brightness range are directly obtained by interpolation from the anchor grayscale (which may be understood as an nth grayscale) and grayscale 0. In the embodiments of the present disclosure, the register values of the grayscales in the third brightness range are obtained by interpolation based on the second register value of the 1st node and grayscale 0. The 1st node is a grayscale, among the n first grayscale nodes, closest to grayscales in the third brightness range. Therefore, the register values of grayscales in the third brightness range obtained by interpolation are more accurate, thereby effectively improving gamma performance of grayscales in the third brightness range.

In some embodiments, in order to further improve the reliability of the register values of the grayscales in the third brightness range obtained by interpolation, the minimum value among grayscales covered by the second brightness range may be set as the 1st node.

In addition, the display panel usually has a plurality of digital brightness values (DBV), and mapping relationships between grayscales and brightness are different at different display brightness values. Therefore, values and quantities of grayscales covered by different display brightness values in the same second brightness range may also be different, and further, the n first grayscale nodes set at different display brightness values may also be different.

For example, at a certain display brightness value, based on the mapping relationship between grayscales and brightness at the display brightness value, if the second brightness range has already covered grayscale 1, then at the display brightness value, the third brightness range does not cover other grayscales except grayscale 0, so that there is no need to have a process of processing register values corresponding to grayscales in the third brightness range. If at a certain display brightness value, based on the mapping relationship between grayscales and brightness at the display brightness value, the second brightness range cannot cover grayscale 1, then at the display brightness value, the third brightness range at least further covers grayscale 1. In this case, the register values corresponding to grayscales in the third brightness range may be acquired through the foregoing interpolation manner.

In a feasible implementation, the method for processing display data further includes: setting a plurality of second grayscale nodes in the first brightness range; driving the second display module to display based on initial register values corresponding to the plurality of second grayscale nodes, collecting brightness data and chromaticity data of the second display module, comparing the collected brightness data and chromaticity data with target data, adjusting register values at the second grayscale nodes and register value ratios of a plurality of color channels at the second grayscale nodes according to a comparison condition until the collected brightness data and chromaticity data conform to the target data, and setting adjusted register values in each of the color channels as the second register values of the second display module in a corresponding color channel at the second grayscale nodes; and burning the second register values corresponding to the second display module at the second grayscale nodes into the second display module.

The process of acquiring the second register values corresponding to the second display module at the second grayscale nodes may specifically include: in each color channel, driving the display panel to display a monochromatic image of a corresponding color based on initial register values at the second grayscale nodes, collecting actual brightness of the display panel using an instrument, comparing the collected brightness with the target brightness, adjusting the register values according to the comparison result until the collected brightness is consistent with the target brightness, and reading the register value adjusted in this process.

Then, the process of acquiring the second register values corresponding to the second display module at the second grayscale nodes may further include: in the color channels, driving the display panel to display a white image based on respective corresponding adjusted register values, collecting the chromaticity data of the display panel using the instrument, comparing the collected chromaticity data with the target chromaticity, and adjusting the register value ratios among the color channels according to the comparison result until the collected chromaticity data is consistent with the target chromaticity. In this case, the adjusted register values are the second register values of the second display module in corresponding color channels at the second grayscale nodes.

The brightness in the first brightness range is relatively high, for example, greater than 0.01 nit, and the measurement errors of the instrument for brightness and chromaticity are relatively small, which can provide a reliable basis for correction. Therefore, for the first brightness range, ratios of register values may be adjusted based on measured chromaticity data, to implement more refined correction and optimize display.

In a feasible implementation, the first brightness range is greater than the second brightness range, and the second brightness range is greater than the third brightness range. In an embodiment, a quantity of grayscales covered in the first brightness range is greater than a quantity of grayscales covered in the second brightness range, and the quantity of grayscales covered in the second brightness range is greater than a quantity of grayscales covered in the third brightness range.

With such division, the range length of the second brightness range is not excessively large, so that the gamma reliability corresponding to a plurality of grayscales in the brightness range can be ensured on the premise that the set quantity of the first grayscale nodes is reasonable. Alternatively, in other words, while ensuring the gamma reliability corresponding to the grayscales in the brightness range, the set quantity of the first grayscale nodes does not need to be excessively large, thereby saving the correction duration for the first display module, and saving the calculation and burning duration of the register values of the 1st node to the (n−1)th node in the second display module.

In a feasible implementation, the process of step S3 may include according to

$$k ( i ) = \frac{RV 1 ( i )}{RV 1 ( i + 1 )} ,$$

sequentially acquiring first coefficients k(n−1) to k(1) corresponding to the (n−1)th node to the 1st node by sequentially taking values for i from n−1, n−2, . . . , and 1, wherein RV1(i) is the first register value corresponding to the first display module at an ith node, and RV1(i+1) is the first register value corresponding to the first display module at an (i+1)th node.

In this way, the first coefficient corresponding to the ith node can intuitively reflect the proportional relationship between the first register values corresponding to the ith node and the (i+1)th node. Further, when the second register value of the second display module at the nth node is obtained by correction, the second register values of the second display module at the (n−1)th node, the (n−2)th node, . . . , the 2nd node, and the 1st node may be gradually derived according to the first coefficients.

In a feasible implementation, the process of step S5 may include according to

RV2(i)=RV2(i+1)×k(i),
sequentially acquiring the second register values RV2(n−1) to RV2(1) corresponding to the second display module at the (n−1)th node to the 1st node by sequentially taking values for i from n−1, n−2, . . . , and 1, where RV2(i) is the second register value corresponding to the second display module at the ith node, and RV2(i+1) is the second register value corresponding to the second display module at the (i+1)th node.

For example, first, according to

RV2(n−1)=RV2(n)×k(n−1),
the second register value RV2(n−1) corresponding to the second display module at the (n−1)th node is obtained.

Then, according to

RV2(n−2)=RV2(n−1)×k(n−2),
the second register value RV2(n−2) corresponding to the second display module at the (n−2)th node is obtained.

By analogy, finally, according to

RV2(1)=RV2(2)×k(1),
the second register value RV2(1) corresponding to the second display module at the 1st node is obtained.

In this implementation, the second register values of the second display module at the 1st node to the (n−1)th node are obtained by directly multiplying the first coefficients, and these obtained second register values are directly burned. These second register values are obtained in a simple manner, which can further reduce the time of the OTP process.

Alternatively, in another feasible implementation, the process of step S5 may include sequentially acquiring second register values RV2(n−1) to RV2(1) corresponding to the second display module at the (n−1)th node to the 1st node by sequentially taking values for i from n−1, n−2, . . . , and 1.

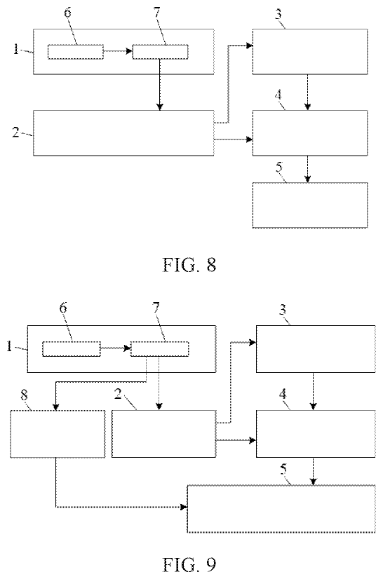

FIG. 7 is another schematic diagram of a method for processing display data according to an embodiment of the present disclosure. As shown in FIG. 7, the process of acquiring a second register value RV2(i) corresponding to the second display module at the ith node includes the following steps.
Step K1: according to RV3(i)=RV2(i+1)×k(i), a third register value RV3(i) corresponding to the second display module at the ith node is acquired, where RV2(i+1) is the second register value corresponding to the second display module at an (i+1)th node.
Step K2: the second display module is controlled to emit light based on the acquired third register value RV3(i), and brightness of the second display module is collected.
Step K3: whether the collected brightness is within a target brightness range is determined; if yes, the acquired third register value RV3(i) is set as the second register value RV2(i) corresponding to the second display module at the ith node; and if no, the first coefficient k(i) is adjusted, and the third register value RV3(i) is re-acquired until the collected brightness of the second display module is within the target brightness range, and the re-obtained third register value RV3(i) is set as the second register value RV2(i) corresponding to the second display module at the ith node.

For example, first, according to RV3(n−1)=RV2(n)×k(n−1), a third register value RV3(n−1) corresponding to the second display module at the (n−1)th node is acquired. A display panel in the second display module is controlled to emit light based on the acquired third register value RV3(n−1), brightness of the display panel is collected, and whether the collected brightness is within the target brightness range is determined. If yes, the acquired third register value RV3(n−1) is set as the second register value RV2(n−1) corresponding to the second display module at the (n−1)th node. If no, the first coefficient k(n−1) is adjusted, and the third register value RV3(n−1) is re-acquired, until the collected brightness satisfies the target brightness, and the re-acquired third register value RV3(n−1) is set as the second register value RV2(n−1) corresponding to the second display module at the (n−1)th node.

Then, according to

RV3(n−2)=RV2(n−1)×k(n−2),
a third register value RV3(n−2) corresponding to the second display module at the (n−2)th node is acquired. The display panel in the second display module is controlled to emit light based on the acquired third register value RV3(n−2), brightness of the display panel is collected, and whether the collected brightness is within the target brightness range is determined. If yes, the acquired third register value RV3(n−2) is set as the second register value RV2(n−2) corresponding to the second display module at the (n−2)th node. If no, the first coefficient k(n−2) is adjusted, and the third register value RV3(n−2) is re-acquired, until the collected brightness of the second display module satisfies the target brightness, and the re-acquired third register value RV3(n−2) is set as the second register value RV2(n−2) corresponding to the second display module at the (n−2)th node.

By analogy, finally, according to

RV3(1)=RV2(2)×k(1),
a third register value RV3(1) corresponding to the second display module at the 1st node is acquired. The display panel in the second display module is controlled to emit light based on the acquired third register value RV3(1), brightness of the display panel is collected, and whether the collected brightness is within the target brightness range is determined. If yes, the acquired third register value RV3(1) is set as the second register value RV2(1) corresponding to the second display module at the 1st node. If no, the first coefficient k(1) is adjusted, and the third register value RV3(1) is re-acquired, until the collected brightness satisfies the target brightness, and the re-acquired third register value RV3(1) is set as the second register value RV2(1) corresponding to the second display module at the 1st node.

The above determining whether the collected brightness is within the target brightness range may be understood as determining whether the collected brightness is equal to the target brightness, or may be understood as determining whether the collected brightness is within a qualified range fluctuating upward and downward around the target brightness. The fluctuating range is the maximum brightness error range allowed in mass production.

The above processing manner adds the process of adjusting register values of the second display module at the 1st node to the (n−1)th node, so that the finally obtained second register values can better match characteristics of the second display module. In addition, it should be noted that, the above adjustment process is adjustment performed on the basis of register values acquired based on the first coefficients, and the register values do not differ greatly from register values corresponding to displaying target brightness. Compared with the adjustment performed on the basis of the initial register values, the adjustment and correction time required by this adjustment manner is very short, and the TT time is not significantly affected. In addition, the register values are adjusted by adjusting the first coefficients, and a certain adjustment ratio is followed during adjustment, so that the adjustment is more accurate and refined, and can be completed with fewer adjustments.

In a feasible implementation, the process of step S3 may include acquiring the first coefficients respectively corresponding to the (n−1)th node to the 1st node in the first color channel according to the acquired first register values respectively corresponding to the first display module at the 1st node to the nth node in a first color channel.

Correspondingly, the process of step S5 may include in each color channel, acquiring the second register values respectively corresponding to the second display module at the (n−1)th node to the 1st node in a corresponding color channel according to the acquired second register value corresponding to the second display module at the nth node and the acquired first coefficients respectively corresponding to the (n−1)th node to the 1st node in the first color channel.

The following uses a red channel, a green channel, and a blue channel as an example for description.

In a specific example, the n first grayscale nodes include grayscale 1, grayscale 3, grayscale 5, and grayscale 7. For the first display module, the acquired first register values respectively corresponding to grayscale 1, grayscale 3, grayscale 5, and grayscale 7 in the blue channel are 464, 546, 729, and 828. The acquired first register values respectively corresponding to grayscale 1, grayscale 3, grayscale 5, and grayscale 7 in the red channel are 204.59736, 426.2445, 539.55, and 545. The acquired first register values respectively corresponding to grayscale 1, grayscale 3, grayscale 5, and grayscale 7 in the green channel are 217, 283.1202, 358.38, and 362.

That is, in the first display module, the blue channel has nodes (1, 464), (3, 546), (5, 729), and (7, 828), and these nodes may correspond to coordinates of 1-B in FIG. 4. The red channel has nodes (1, 204.59736), (3, 426.2445), (5, 539.55), and (7, 545), and these nodes may correspond to coordinates of 1-R in FIG. 4. The green channel has nodes (1, 217), (3, 283.1202), (5, 358.38), and (7, 362), and these nodes may correspond to coordinates of 1-G in FIG. 4.

When the first color is red, according to the acquired first register values 204.59736, 426.2445, 539.55, and 545 at grayscale 1, grayscale 3, grayscale 5, and grayscale 7 in the red channel, first coefficients respectively corresponding to grayscale 1, grayscale 3, and grayscale 5 are calculated.

The first coefficient corresponding to grayscale 5 is

$$\frac{539.55}{545} = 0.99 ,$$

the first coefficient corresponding to grayscale 3 is

$$\frac{426.2445}{539.55} = 0.79 ,$$

and the first coefficient corresponding to grayscale 1 is

$$\frac{204.59736}{426.2445} = 0.48 .$$

Further, in the second display module, when the second register value corresponding to grayscale 7 in blue channel is acquired as A, the second register value corresponding to grayscale 5 in the blue channel is A×0.99, the second register value corresponding to grayscale 3 in the blue channel is A×0.99×0.79, and the second register value corresponding to grayscale 1 in the blue channel is Ax0.99×0.79×0.48.

When the second register value corresponding to grayscale 7 in the red channel is acquired as B, the second register value corresponding to grayscale 5 in the red channel is B×0.99, the second register value corresponding to grayscale 3 in the red channel is B×0.99×0.79, and the second register value corresponding to grayscale 1 in the red channel is Bx0.99×0.79×0.48.

When the second register value corresponding to grayscale 7 in the green channel is acquired as C, the second register value corresponding to grayscale 5 in the green channel is C×0.99, the second register value corresponding to grayscale 3 in the green channel is C×0.99×0.79, and the second register value corresponding to grayscale 1 in the green channel is C×0.99×0.79×0.48.

In such a processing manner, the first coefficients are acquired only based on first register values in a single color channel, the calculation amount for acquiring the first coefficients is relatively small, so that the overall OTP time can be further reduced.

Verification is further carried out based on the above specific numerical values in the embodiments of the present disclosure.

As described above, for the first display module, the acquired first register values respectively corresponding to grayscale 1, grayscale 3, grayscale 5, and grayscale 7 in the blue channel are 464, 546, 729, and 828. The acquired first register values respectively corresponding to grayscale 1, grayscale 3, grayscale 5, and grayscale 7 in the red channel are 204.59736, 426.2445, 539.55, and 545. The acquired first register values respectively corresponding to grayscale 1, grayscale 3, grayscale 5, and grayscale 7 in the green channel are 217, 283.1202, 358.38, and 362. These nodes may correspond to coordinates of 1-B, 1-R, and 1-G in FIG. 4.

Further, the first coefficient at grayscale 5 is obtained as 0.99, the first coefficient at grayscale 3 is obtained as 0.79, and the first coefficient at grayscale 1 is obtained as 0.48.

It is assumed that the second register values at grayscale 7 respectively in the blue channel, the red channel and the green channel acquired by the second display module are also 828, 545, and 362.

Further, in the second display module, in the blue channel, the second register value corresponding to grayscale 5 is 819.72 (828×0.99), the second register value corresponding to grayscale 3 is 647.5788 (819.72×0.79), and the second register value corresponding to grayscale 1 is 310.837824 (647.5788×0.48); in the red channel, the second register value corresponding to grayscale 5 is 539.55 (545×0.99), the second register value corresponding to grayscale 3 is 426.2445 (539.55×0.79), and the second register value corresponding to grayscale 1 is 204.59736 (426.2445×0.48); in the green channel, the second register value corresponding to grayscale 5 is 358.38 (362×0.99), the second register value corresponding to grayscale 3 is 283.1202 (358.38×0.79), and the second register value corresponding to grayscale 1 is 135.897696 (283.1202×0.48).

That is, for the second display module, nodes corresponding to the blue channel are (1, 310.837824), (3, 647.5788), (5, 819.72), and (7, 828), nodes corresponding to the red channel are (1, 204.59736), (3, 426.2445), (5, 539.55), and (7, 545), and nodes corresponding to the green channel are (1, 135.897696), (3, 283.1202), (5, 358.38), and (7, 362). These nodes may correspond to coordinates of 3-B, 3-R, and 3-G in FIG. 4.

Under the condition that register values corresponding to grayscale 7 are the same, by comparing coordinates of 1-B, 1-R, 1-G and 3-B, 3-R, 3-G in FIG. 4, it can be seen that register values calculated based on the method of the embodiments of the present disclosure do not differ greatly from actually corrected register values, and the two tend to be consistent. It can thus be seen that, when the second register values of the second display module at the 1st node to the (n−1)th node are acquired based on the method, these second register values tend to approach register values actually required by the second display module when displaying target brightness of the 1st node to the (n−1)th node, thereby realizing the correction effect on gamma of the second display module.

Further, compared with blue light and red light, brightness deviation of green light has a greater impact on overall display. Therefore, in the embodiments of the present disclosure, the first color channel may be set as a green channel, and the first coefficients are acquired based on the first register values in the green channel, so that the correction accuracy of register values of the second display module in the green channel can be improved to a greater extent.

Alternatively, in another feasible implementation, the process of step S3 may include in each color channel, acquiring first coefficients respectively corresponding to the 1st node to the (n−1)th node in a corresponding color channel according to the first register values acquired in the corresponding color channel.

Correspondingly, the process of step S5 may include in each color channel, acquiring second register values respectively corresponding to the second display module in the corresponding color channel at the (n−1)th node to the 1st node according to the second register value corresponding to the second display module at the nth node acquired in the corresponding color channel and the acquired first coefficients respectively corresponding to the (n−1)th node to the 1st node in the corresponding color channel.

Still taking the foregoing numerical values as an example, in the blue channel, the first coefficient corresponding to grayscale 5 is

$$\frac{729}{828} = 0.88 ,$$

the first coefficient corresponding to grayscale 3 is

$$\frac{546}{729} = 0.75 ,$$

and the first coefficient corresponding to grayscale 1 is

$$\frac{464}{546} = 0.85 .$$

Further, in the second display module, when the second register value corresponding to grayscale 7 in the blue channel is acquired as A, the second register value corresponding to grayscale 5 in the blue channel is A×0.88, the second register value corresponding to grayscale 3 in the blue channel is A×0.88×0.75, and the second register value corresponding to grayscale 1 in the blue channel is A×0.88×0.75×0.85.

In the red channel, the first coefficient corresponding to grayscale 5 is

$$\frac{539.55}{545} = 0.99 ,$$

the first coefficient corresponding to grayscale 3 is

$$\frac{426.2445}{539.55} = 0.79 ,$$

and the first coefficient corresponding to grayscale 1 is

$$\frac{204.59736}{426.2445} = 0.48 .$$

Further, in the second display module, when the second register value corresponding to grayscale 7 in the red channel is acquired as B, the second register value corresponding to grayscale 5 in the red channel is B×0.99, the second register value corresponding to grayscale 3 in the red channel is Bx0.99×0.79, and the second register value corresponding to grayscale 1 in the red channel is Bx0.99×0.79×0.48.

In the green channel, the first coefficient corresponding to grayscale 5 is

$$\frac{358.38}{362} = 0.99 ,$$

the first coefficient corresponding to grayscale 3 is

$$\frac{283.1202}{358.38} = 0.79 ,$$

and the first coefficient corresponding to grayscale 1 is

$$\frac{217}{358.38} = 0.61 .$$

Further, in the second display module, when the second register value corresponding to grayscale 7 in the green channel=is acquired as C, the second register value corresponding to grayscale 5 in the green channel is C×0.99, the second register value corresponding to grayscale 3 in the green channel is C×0.99×0.79, and the second register value corresponding to grayscale 1 in the green channel is C×0.99×0.79×0.61.

In such a processing manner, the first coefficients are respectively calculated for each color channel, and further, in different color channels of the second display module, the second register values respectively corresponding to the corresponding color channel at the (n−1)th node to the 1st node are calculated based on the first coefficients in the corresponding color channel. The reliability of the second register values of the second display module at the 1st node to the (n−1)th node acquired by such a processing manner is higher, and the improvement effect on gamma of the second display module is better.

Based on the same inventive concept, an embodiment of the present disclosure further provides a device for processing display data, which corresponds to the method for processing display data described above.

FIG. 8 is a schematic diagram of a device for processing display data according to an embodiment of the present disclosure. As shown in FIG. 8, the device for processing display data includes a setting module 1, an acquisition module 2, a first processing module 3, a second processing module 4, and a burning module 5.

The setting module 1 is configured to set n first grayscale nodes, where n>1. The first grayscale nodes include a 1st node to an nth node, and grayscale values of the 1st node to the nth node increase progressively.

In the embodiments of the present disclosure, other grayscales may be spaced between two adjacent first grayscale nodes, and quantities of grayscales spaced between different adjacent first grayscale nodes may be the same or may be different.

The acquisition module 2 is configured to acquire first register values respectively corresponding to the first display module at the 1st node to the nth node, and acquire a second register value corresponding to the second display module at the nth node. The first register values are register values for driving the first display module to display target brightness at corresponding first grayscale nodes, and may also be understood as corrected register values corresponding to the first display module at the first grayscale nodes. The second register value corresponding to the second display module at the nth node is a register value for driving the second display module to display target brightness at the nth node, and may also be understood as a corrected register value corresponding to the second display module at the nth node.

When acquiring the first register values respectively corresponding to the first display module at the 1st node to the nth node, the acquisition module 2 is configured to drive a display panel in the first display module to display based on initial register values corresponding to the first grayscale nodes, collect actual brightness of the display panel using an instrument, compare the collected brightness with the target brightness, and adjust register values according to the comparison result until the collected brightness is consistent with the target brightness. The acquisition module 2 is configured to read the adjusted register values, and the adjusted register values are the first register values.

When acquiring the second register value corresponding to the second display module at the nth node, the acquisition module 2 is configured to drive the display panel in the second display module to display based on the initial register value corresponding to the nth node, collect the actual brightness of the display panel using an instrument, compare the collected brightness with the target brightness, and adjust the register value according to the comparison result until the collected brightness is consistent with the target brightness. The acquisition module 2 is configured to read the adjusted register value, and the adjusted register value is the second register value corresponding to the second display module at the nth node.

The first processing module 3 is configured to acquire first coefficients respectively corresponding to the 1st node to an (n−1)th node according to the acquired first register values.

The second processing module 4 is configured to acquire second register values respectively corresponding to the second display module at the 1st node to the (n−1)th node according to the acquired second register value corresponding to the second display module at the nth node and the acquired first coefficients respectively corresponding to the 1st node to the (n−1)th node.

The burning module 5 is configured to burn the second register values corresponding to the second display module at the n first grayscale nodes into the second display module.

In the embodiments of the present disclosure, register values of the first display module at the n first grayscale nodes are separately corrected to obtain n first register values, and the first coefficients respectively corresponding to the 1st node to the (n−1)th node are acquired according to the n first register values. These first coefficients may reflect the correlation between the first register values corresponding to different first grayscale nodes. Further, in the second display module, only a register value of the second display module at the nth node is corrected to obtain the second register value corresponding to the second display module at the nth node. Combined with the first coefficients, the second register values corresponding to the second display module at the 1st node to the (n−1)th node are directly acquired. Further, the second register value of the second display module at the nth node obtained by correction and the second register values of the second display module at the 1st node to the (n−1)th node calculated based on the first coefficients are all burned into a driving chip of the second display module, and all are used as reference bases for other grayscales, for example, as calculation bases for register values of other grayscales between adjacent first grayscale nodes. The register values of the other grayscales between adjacent first grayscale nodes may be obtained using a linear interpolation algorithm based on register values of the adjacent first grayscale nodes, thereby improving reliability of the obtained register values of other grayscales, and further optimizing the gamma curve.

In the embodiments of the present disclosure, register values of a greater number of grayscale nodes may be burned into the second display module, to provide more references for calculation of register values of other grayscales. In addition, the burned register values of these grayscale nodes only need to be obtained according to the first coefficients without performing a complicated correction process on the basis of initial register values, so that the time of the OTP process is not greatly affected.

Further, the above processing manner according to the embodiments of the present disclosure may be applied to a low-grayscale range. During research, it has been found that in the related art, a linear interpolation algorithm is generally used to process register values of grayscales in a low-grayscale range, but the register values acquired in this way differ greatly from register values actually required by the display panel, resulting in unsmooth gamma in the low-grayscale range. If low grayscales are directly processed using a debugging algorithm corresponding to high grayscales, in a process of processing register values of the low grayscales, register value ratios among different color channels need to be continuously corrected according to chromaticity data measured by an instrument. This process greatly prolongs the correction time and slows down the production line takt time. In addition, the measured chromaticity data of the instrument at low brightness has a large error. Adjusting the register value ratios based on such erroneous data causes the correction direction to deviate, and instead results in more serious color cast.

By adopting the processing manner according to the embodiments of the present disclosure, the above problems can be effectively overcome. In the embodiments of the present disclosure, the n first grayscale nodes may be set in one low-grayscale range, and then register values corresponding to a greater number of lower grayscales are burned into the second display module based on the foregoing processing manner as reference values, so as to optimize reliability of the register values in the entire low-grayscale range. Such a manner can not only overcome the problem of unsmooth gamma caused by the linear interpolation algorithm at low grayscales and effectively improve low-grayscale visual effects, but also overcome the serious color cast problem caused by causing the low grayscales to follow the debugging algorithm corresponding to high grayscales, and does not greatly increase correction time, thereby keeping the TT baseline.

In addition, in the embodiments of the present disclosure, among the 1st node to the nth node, the register value of the nth node is selected to be corrected, and then the register values corresponding to the 1st node to the (n−1)th node are calculated and obtained based on the first coefficients. The grayscale value of the nth node is relatively high, and the corresponding brightness is relatively large. Therefore, an error when the instrument collects brightness is relatively small. Selecting the register value of the nth node to be corrected is less affected by the error of brightness collection by the instrument, the correction reliability is higher, and the obtained register values of the 1st node to the (n−1)th node are also more accurate.

In a feasible implementation, referring to FIG. 8 again, the setting module 1 includes a first unit 6 and a second unit 7. With reference to FIG. 6, the first unit 6 is configured to divide a first brightness range, a second brightness range, and a third brightness range according to panel brightness. A brightness value in the first brightness range is greater than a brightness value in the second brightness range, and the brightness value in the second brightness range is greater than a brightness value in the third brightness range. The second unit 7 is configured to set the n first grayscale nodes in the second brightness range.

In the embodiments of the present disclosure, a plurality of different brightness ranges are divided, and then the n first grayscale nodes are set in a certain brightness range, so that the processing manner of the embodiments of the present disclosure is applied to grayscales in the brightness range in a targeted manner. For example, as described above, in the related art, the processing manner in the low-grayscale range is poor, which causes some adverse problems. Therefore, in the embodiments of the present disclosure, a low-brightness second brightness range may be divided, so as to improve low-grayscale visual effects in a targeted manner.

In a feasible implementation, the device for processing display data further includes a third processing module that may be located in a driver chip of the second display module. The third processing module is configured to acquire, for at least one display brightness value, second register values corresponding to grayscale values of the second display module in the third brightness range through a linear interpolation algorithm, according to a register value corresponding to grayscale 0 and the acquired second register value corresponding to the second display module at the 1st node.

In the embodiments of the present disclosure, the register value corresponding to grayscale 0 may be 0.

The brightness values in the third brightness range are very low, for example, below 0.0005 nit, and the measurement error of the instrument in the brightness range is relatively large. Therefore, when the third brightness range covers grayscales, if register values of these grayscales are corrected based on brightness collected by the instrument, the correction result is also inaccurate. Therefore, for the third brightness range, according to the embodiments of the present disclosure, the register values corresponding to the grayscales covered by the third brightness range may be directly obtained through a linear interpolation algorithm according to the register value corresponding to grayscale 0 and the previously obtained second register value corresponding to the second display module at the 1st node, thereby omitting correction and burning for the third brightness range.

In the related art, the register values of the grayscales in the third brightness range are directly obtained by interpolation based on the anchor grayscale (which may be understood as an nth grayscale), and grayscale 0. In the embodiments of the present disclosure, the register values of the grayscales in the third brightness range are obtained by interpolation based on the second register value of the 1st node and grayscale 0. The 1st node is a grayscale, among the n first grayscale nodes, closest to grayscales in the third brightness range. Therefore, the register values of grayscales in the third brightness range obtained by interpolation are more accurate, thereby effectively improving gamma performance of grayscales in the third brightness range.

In a feasible implementation, the second unit 7 is further configured to set second grayscale nodes in the first brightness range.

FIG. 9 is another schematic diagram of a device for processing display data according to an embodiment of the present disclosure. As shown in FIG. 9, the device for processing display data further includes a fourth processing module 8. The fourth processing module is configured to drive the second display module to display based on initial register values corresponding to the second grayscale nodes, collect brightness data and chromaticity data of the second display module, compare the collected brightness data and chromaticity data with target data, adjust register values at the second grayscale nodes and register value ratios of the second grayscale nodes in each of a plurality of color channels according to a comparison condition until the collected brightness data and chromaticity data conform to the target data, and set adjusted register values in each of the plurality of color channels as the second register values of the second display module at the second grayscale nodes in a corresponding color channel.

The burning module 5 is further configured to burn the second register values of the second display module at the second grayscale nodes into the second display module.

The process of acquiring the second register values corresponding to the second display module at the second grayscale nodes may specifically include the following steps.

In each color channel, the display panel is driven to display a monochromatic image of a corresponding color based on initial register values at the second grayscale nodes, the actual brightness of the display panel is collected using an instrument, the collected brightness is compared with the target brightness, and the register values are adjusted according to the comparison result until the collected brightness is consistent with the target brightness, and the register values adjusted in this process are read.

Then, in a plurality of color channels, the display panel is driven to display a white image based on respective corresponding adjusted register values, the chromaticity data of the display panel is collected using the instrument, the collected chromaticity data is compared with the target chromaticity, and the register value ratios in each of the color channels are adjusted according to the comparison result until the collected chromaticity data is consistent with the target chromaticity. In this case, the adjusted register values are the second register values of the second display module in the corresponding color channel at the second grayscale nodes.

The brightness in the first brightness range is relatively high, for example, greater than 0.01 nit, and the measurement errors of the instrument for brightness and chromaticity are relatively small, which can provide a reliable basis for correction. Therefore, for the first brightness range, ratios of register values may be adjusted based on measured chromaticity data, so as to implement more refined correction and optimize display.

The above description is only preferred embodiments of the present disclosure and is not intended to limit the present disclosure, and any modifications, equivalent substitutions, improvements and the like made within the spirit and principle of the present disclosure should be included within the protection scope of the present disclosure.

As above, it should be noted that, the above-described embodiments are merely for illustrating the present disclosure but not intended to provide any limitation. Although the present disclosure has been described in detail with reference to the above-described embodiments, it should be understood that those skilled in the art may also modify the technical solutions described in the above embodiments or to equivalently replace some or all of the technical features therein, but these modifications or replacements do not cause the essence of corresponding technical solutions to depart from the scope of the present disclosure.

What is claimed is:

1. A method for processing display data, the method comprising:
setting n first grayscale nodes, wherein the n first grayscale nodes comprise a 1st node to an nth node, and grayscale values of the 1st node to the nth node increase progressively, where n>1;
acquiring first register values respectively corresponding to a first display module at the 1st node to the nth node, wherein the first register values are register values for driving the first display module to display target brightness at the first grayscale nodes, respectively;
acquiring first coefficients respectively corresponding to the 1st node to an (n−1)th node based on the acquired first register values;
acquiring a second register value corresponding to a second display module at the nth node, wherein the second register value corresponding to the second display module at the nth node is a register value for driving the second display module to display target brightness at the nth node;
acquiring second register values respectively corresponding to the second display module at the 1st node to the (n−1)th node based on the acquired second register value corresponding to the second display module at the nth node and the acquired first coefficients respectively corresponding to the 1st node to the (n−1)th node; and
burning the second register values corresponding to the second display module at the n first grayscale nodes into the second display module.

2. The method according to claim 1, wherein the first display module is a test display module, and the second display module is a display module to be burned.

3. The method according to claim 1, wherein a brightness value corresponding to the 1st node is greater than or equal to 0.0005 nit.

4. The method according to claim 1, wherein a brightness value corresponding to the nth node is less than or equal to 0.01 nit.

5. The method according to claim 1, wherein the setting the n first grayscale nodes comprises:
dividing a first brightness range, a second brightness range and a third brightness range based on panel brightness; and
setting the n first grayscale nodes in the second brightness range,
wherein a brightness value in the first brightness range is greater than a brightness value in the second brightness range, and the brightness value in the second brightness range is greater than a brightness value in the third brightness range.

6. The method according to claim 5, wherein the second brightness range is [0.0005 nit, 0.01 nit].

7. The method according to claim 5, further comprising:
acquiring, under at least one display brightness value, register values corresponding to grayscales of the second display module in the third brightness range through a linear interpolation algorithm, based on a register value corresponding to grayscale 0 and the acquired second register value corresponding to the second display module at the 1st node.

8. The method according to claim 5, further comprising:
setting a plurality of second grayscale nodes in the first brightness range;
driving the second display module to display based on initial register values corresponding to the plurality of second grayscale nodes, collecting brightness data and chromaticity data of the second display module, comparing the collected brightness data and chromaticity data with target data, adjusting register values at the second grayscale nodes and register value ratios of a plurality of color channels at the second grayscale nodes based on a comparison condition until the collected brightness data and chromaticity data conform to the target data, and setting the adjusted register values of each of the plurality of color channels as the second register values of the second display module in a corresponding one of the plurality of color channels at the second grayscale nodes; and
burning the second register values corresponding to the second display module at the second grayscale nodes into the second display module.

9. The method according to claim 5, wherein the first brightness range is greater than the second brightness range, and the second brightness range is greater than the third brightness range; and/or
a quantity of grayscales covered in the first brightness range is greater than a quantity of grayscales covered in the second brightness range, and the quantity of grayscales covered in the second brightness range is greater than a quantity of grayscales covered in the third brightness range.

10. The method according to claim 1, wherein the acquiring the first coefficients respectively corresponding to the 1st node to the (n−1)th node based on the acquired first register values comprises:
sequentially acquiring first coefficients k(n−1) to k(1) corresponding to the (n−1)th node to the 1st node by sequentially taking values for i from n−1, n−2, . . . , and 1, based on
$$k ( i ) = \frac{RV 1 ( i )}{RV 1 ( i + 1 )} ,$$
wherein RV1(i) is a first register value corresponding to the first display module at an ith node, and RV1(i+1) is a first register value corresponding to the first display module at an (i+1)th node.

11. The method according to claim 10, wherein the acquiring the second register values respectively corresponding to the second display module at the 1st node to the (n−1)th node based on the acquired second register value corresponding to the second display module at the nth node and the acquired first coefficients respectively corresponding to the 1st node to the (n−1)th node comprises:
sequentially acquiring second register values RV2(n−1) to RV2(1) corresponding to the second display module at the (n−1)th node to the 1st node by sequentially taking values for i from n−1, n−2, . . . , and 1, based on RV2(i)=RV2(i+1)× k(i),
wherein RV2(i) is a second register value corresponding to the second display module at the ith node, and RV2(i+1) is a second register value corresponding to the second display module at the (i+1)th node.

12. The method according to claim 10, wherein the acquiring the second register values respectively corresponding to the second display module at the 1st node to the (n−1)th node based on the acquired second register value corresponding to the second display module at the nth node and the acquired first coefficients respectively corresponding to the 1st node to the (n−1)th node comprises:
sequentially acquiring second register values RV2(n−1) to RV2(1) corresponding to the second display module at the (n−1)th node to the 1st node,
wherein the acquiring the second register value RV2(i) corresponding to the second display module at the ith node by sequentially taking values for i from n−1, n−2, . . . , and 1 comprises:
acquiring a third register value RV3(i) corresponding to the second display module at the ith node, based on
RV3(i)=RV2(i+1)×k(i),
wherein RV2(i+1) is a second register value corresponding to the second display module at the (i+1)th node;
controlling the second display module to emit light based on the acquired third register value RV3(i), and collecting brightness of the second display module;
determining whether the collected brightness is within a target brightness range;
setting the acquired third register value RV3(i) as the second register value RV2(i) corresponding to the second display module at the ith node in response to the collected brightness being within a target brightness range; and
adjusting the first coefficient k(i), and re-acquiring a third register value RV3(i) until the collected brightness of the second display module is within the target brightness range in response to the collected brightness being out of the target brightness range, and setting the re-acquired third register value RV3(i) as the second register value RV2(i) corresponding to the second display module at the ith node.

13. The method according to claim 1, wherein the acquiring the first coefficients respectively corresponding to the 1st node to the (n−1)th node based on the acquired first register values comprises:
acquiring the first coefficients respectively corresponding to the (n−1)th node to the 1st node in a first color channel based on the acquired first register values respectively corresponding to the first display module at the 1st node to the nth node in the first color channel; and
wherein the acquiring the second register values respectively corresponding to the second display module at the 1st node to the (n−1)th node based on the acquired second register value corresponding to the second display module at the nth node and the acquired first coefficients respectively corresponding to the 1st node to the (n−1)th node comprises:
for a plurality of color channels, acquiring second register values respectively corresponding to the second display module at the (n−1)th node to the 1st node in each of the plurality of color channels, based on the acquired second register value corresponding to the second display module at the nth node and the acquired first coefficients respectively corresponding to the (n−1)th node to the 1st node in the first color channel.

14. The method according to claim 13, wherein the first color channel is a green channel.

15. The method according to claim 1, wherein the acquiring the first coefficients respectively corresponding to the 1st node to the (n−1)th node based on the acquired first register values comprises:
for a plurality of color channels, acquiring the first coefficients respectively corresponding to the 1st node to the (n−1)th node in each of the plurality of color channels, based on the first register values acquired in a corresponding one of the plurality of color channels; and
wherein the acquiring the second register values respectively corresponding to the second display module at the 1st node to the (n−1)th node based on the acquired second register value corresponding to the second display module at the nth node and the acquired first coefficients respectively corresponding to the 1st node to the (n−1)th node comprises:
for the plurality of color channels, acquiring the second register values respectively corresponding to the second display module at the (n−1)th node to the 1st node in each of the plurality of color channels, based on the second register value corresponding to the second display module at the nth node acquired in a corresponding one of the plurality of color channels and the acquired first coefficients respectively corresponding to the (n−1)th node to the 1st node in the corresponding one of the plurality of color channels.

16. A device for processing display data, comprising:
a setting module configured to set n first grayscale nodes, wherein the first grayscale nodes comprise a 1st node to an nth node, and grayscale values of the 1st node to the nth node increase progressively, where n>1;
an acquisition module configured to acquire first register values respectively corresponding to a first display module at the 1st node to the nth node, and acquire a second register value corresponding to a second display module at the nth node, wherein the first register values are register values for driving the first display module to display target brightness at the first grayscale nodes respectively, and the second register value corresponding to the second display module at the nth node is a register value for driving the second display module to display target brightness at the nth node;
a first processing module configured to acquire first coefficients respectively corresponding to the 1st node to an (n−1)th node based on the acquired first register values;
a second processing module configured to acquire second register values respectively corresponding to the second display module at the 1st node to the (n−1)th node based on the acquired second register value corresponding to the second display module at the nth node and the acquired first coefficients respectively corresponding to the 1st node to the (n−1)th node; and
a burning module configured to burn the second register values corresponding to the second display module at the n first grayscale nodes into the second display module.

17. The device according to claim 16, wherein the setting module comprises:
a first unit configured to divide a first brightness range, a second brightness range and a third brightness range based on panel brightness, wherein a brightness value in the first brightness range is greater than a brightness value in the second brightness range, and the brightness value in the second brightness range is greater than a brightness value in the third brightness range; and
a second unit configured to set the n first grayscale nodes in the second brightness range.

18. The device according to claim 17, further comprising:
a third processing module configured to acquire, under at least one display brightness value, the second register values corresponding to grayscales of the second display module in the third brightness range through a linear interpolation algorithm, based on a register value corresponding to grayscale 0 and the acquired second register value corresponding to the second display module at the 1st node.

19. The device according to claim 17, wherein the second unit is further configured to set second grayscale nodes in the first brightness range;
the device further comprises:
a fourth processing module configured to: drive the second display module to display based on initial register values corresponding to the second grayscale nodes, collect brightness data and chromaticity data of the second display module, compare the collected brightness data and chromaticity data with target data, adjust register values at the second grayscale nodes and register value ratios of a plurality of color channels at the second grayscale nodes based on a comparison condition until the collected brightness data and chromaticity data conform to the target data, and set the adjusted register values of each of the plurality of color channels as the second register values of the second display module in a corresponding one of the plurality of color channels at the second grayscale nodes; and
the burning module is further configured to burn the second register values of the second display module at the second grayscale nodes into the second display module.
